(19) United States
(12) Patent Application Publication
(10) Pub. No.: US 2013/0197684 A1
(43) Pub. Date: Aug. 1, 2013

(54) PARAMETER DETERMINATION SUPPORT METHOD, PARAMETER DETERMINATION SUPPORT PROGRAM, AND PARAMETER DETERMINATION SUPPORT SYSTEM

(71) Applicants: Yasuhisa OOMURO, Tokyo (JP); Nobuichi Kuramochi, Tokyo (JP)

(72) Inventors: Yasuhisa OOMURO, Tokyo (JP); Nobuichi Kuramochi, Tokyo (JP)

(73) Assignee: Kabushiki Kaisha Toshiba, Tokyo (JP)

(21) Appl. No.: 13/599,875

(22) Filed: Aug. 30, 2012

(30) Foreign Application Priority Data
Jan. 26, 2012 (JP) 2012-014647

(51) Int. Cl. G06F 19/00

(52) U.S. Cl. 700/97

(57) ABSTRACT

According to one embodiment, a parameter determination support method includes extracting a first and second parameters that are interaction factors from parameters used in manufacturing of a product, and creating an experimental design, the first parameter being assigned to a signal factor in a dynamic characteristic and the second parameter and another parameter being assigned to control factors in the experimental design. The method further includes setting a characteristic curve expressing a relationship between the signal factor and the characteristic in regard to an experimental result based on the experimental design, and determining a value of the first parameter, a value of the second parameter, and a value of the other parameter satisfying the characteristic of the objective and minimizing a manufacturing variation of the product out of values of the first, the second, and the other parameters as optimum values in accordance with the characteristic curve.

### CROSS-REFERENCE TO RELATED APPLICATIONS

This application is based upon and claims the benefit of priority from the prior Japanese Patent Application No. 2012-014647, filed on Jan. 26, 2012; the entire contents of which are incorporated herein by reference.

### FIELD

Embodiments described herein relate generally to a parameter determination support method, a parameter determination support program, and a parameter determination support system.

### BACKGROUND

When a product is designed, the values of a plurality of parameters that are manufacturing conditions for the product are determined. Here, as methods for determining parameters satisfying the characteristics of the objective and suppressing manufacturing variations, optimization methods such as design of experiments, response surface methodology, and Taguchi methods are developed.

In the determination of parameters using such optimization methods, it is important to determine parameters with sufficient consideration of interaction.

### BRIEF DESCRIPTION OF THE DRAWINGS

FIG. 1 is a flow chart illustrating the flow of a parameter determination support method according to a first embodiment;

FIG. 2 is a flow chart showing a specific example of the parameter determination support method according to the first embodiment;

FIG. 3 is a diagram illustrating interactions by combinations of a plurality of parameters;

FIG. 4 is a diagram illustrating the extraction of an interaction;

FIGS. 5A to 5B are diagrams illustrating relationships between the signal factor and the characteristics;

FIGS. 6A to 6B are diagrams illustrating a comparison between a reference example and the embodiment; and

FIG. 7 is a block diagram showing a configuration of a parameter determination support system according to a third embodiment.

### DETAILED DESCRIPTION

In general, according to one embodiment, a parameter determination support method includes: extracting at least a first parameter and a second parameter that are interaction factors from a plurality of parameters used in manufacturing of a product satisfying a characteristic of an objective; creating an experimental design, the first parameter being assigned to a signal factor in a dynamic characteristic and the second parameter and another parameter being assigned to control factors in the experimental design; setting a characteristic curve expressing a relationship between the signal factor and the characteristic in regard to an experimental result based on the experimental design; and determining a value of the first parameter, a value of the second parameter, and a value of the other parameter satisfying the characteristic of the objective and minimizing a manufacturing variation of the product out of values of the first parameter, the second parameter, and the other parameter as optimum values in accordance with the characteristic curve.

According to another embodiment, a parameter determination support system includes: an input unit, a plurality of parameters used in manufacturing of a product satisfying a characteristic of an objective being inputted to the input unit; an extraction unit configured to extract at least a first parameter and a second parameter that are interaction factors from the plurality of parameters inputted through the input unit; a creation unit configured to create an experimental design, the first parameter extracted in the extraction unit being assigned to a signal factor in a dynamic characteristic and the second parameter and another parameter extracted in the extraction unit being assigned to control factors in the experimental design; a setting unit configured to set a characteristic curve expressing a relationship between the signal factor and the characteristic in regard to an experimental result based on the experimental design created in the creation unit; a determination unit configured to determine a value of the first parameter, a value of the second parameter, and a value of the other parameter satisfying the characteristic of the objective and minimizing a manufacturing variation of the product out of values of the first parameter, the second parameter, and the other parameter as optimum values in accordance with the characteristic curve set in the setting unit; and an output unit configured to output the optimum values determined in the determination unit.

Hereinbelow, embodiments of the invention are described based on the drawings.

### First Embodiment

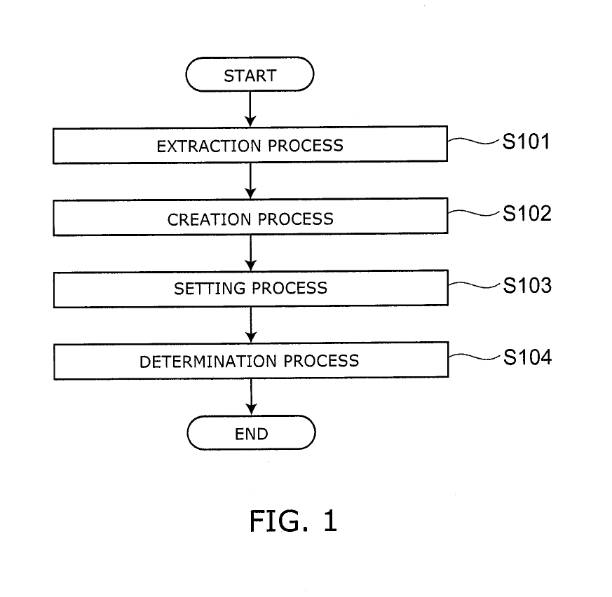

FIG. 1 is a flow chart illustrating the flow of a parameter determination support method according to a first embodiment.

The parameter determination support method is a method of supporting determining the values of a plurality of parameters used in manufacturing a product.

As shown in FIG. 1, the parameter determination support method according to the first embodiment includes an extraction process (step S101), a creation process (step S102), a setting process (step S103), and a determination process (step S104).

In the extraction process (step S101), at least a first parameter and a second parameter that are interaction factors are extracted from a plurality of parameters used in the manufacturing of a product satisfying the characteristics of the objective.

Here, the interaction factor refers to a factor having a relationship in which the effect of the level of one factor changes with the level of another factor in quality engineering.

In the creation process (step S102), an experimental design is created in which the first parameter extracted in the extraction process (step S101) is assigned to a signal factor in dynamic characteristics and the second parameter and the other parameters are assigned to control factors.

Here, the dynamic characteristics refer to the characteristics that characteristics (response) change with a signal factor in Taguchi methods in quality engineering.

The control factor is a design parameter assigned on the inner orthogonal array in design of experiments.

In the setting process (step S103), in regard to the experimental results based on the experimental design created in the creation process (step S102), a characteristic curve expressing the relationship between the signal factor and the characteristics is set.

In the determination process (step S104), in accordance with the characteristic curve set in the setting process (step S103), a value of the first parameter, a value of the second parameter, and values of the other parameters satisfying the characteristics of the objective and minimizing manufacturing variations of the product out of the values of the first parameter, the second parameter, and the other parameters are determined as optimum values.

In the embodiment like this, an experimental design is created while an interaction factor is not excluded from the evaluation but assigned to a signal factor in dynamic characteristics. Thereby, even when there is a great influence of interaction between parameters and it is difficult to find an optimum solution, an optimum solution is outputted for parameters including an interaction factor.

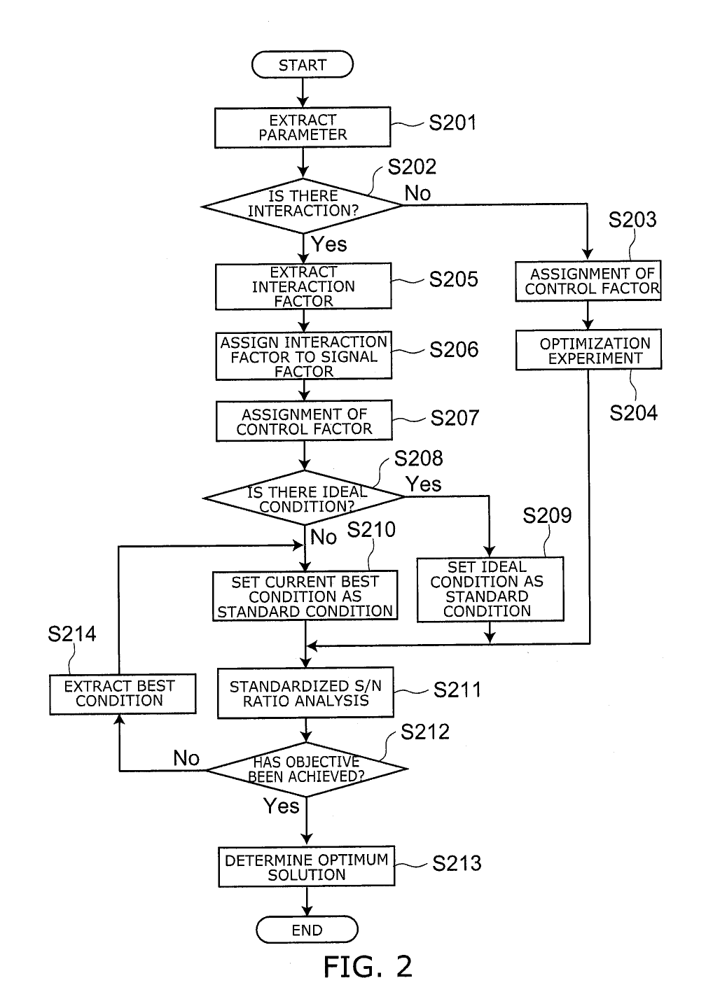

FIG. 2 is a flow chart showing a specific example of the parameter determination support method according to the first embodiment.

First, parameters are extracted (step S201) and a list of the parameters is prepared. Next, by analyzing the list of the parameters and experimental data, it is assessed whether or not there is a parameter having an interaction (an interaction factor) among the plurality of parameters (step S202). The interaction refers to a quantity expressing the degree to which the effect of the level of one factor changes with the level of another factor.

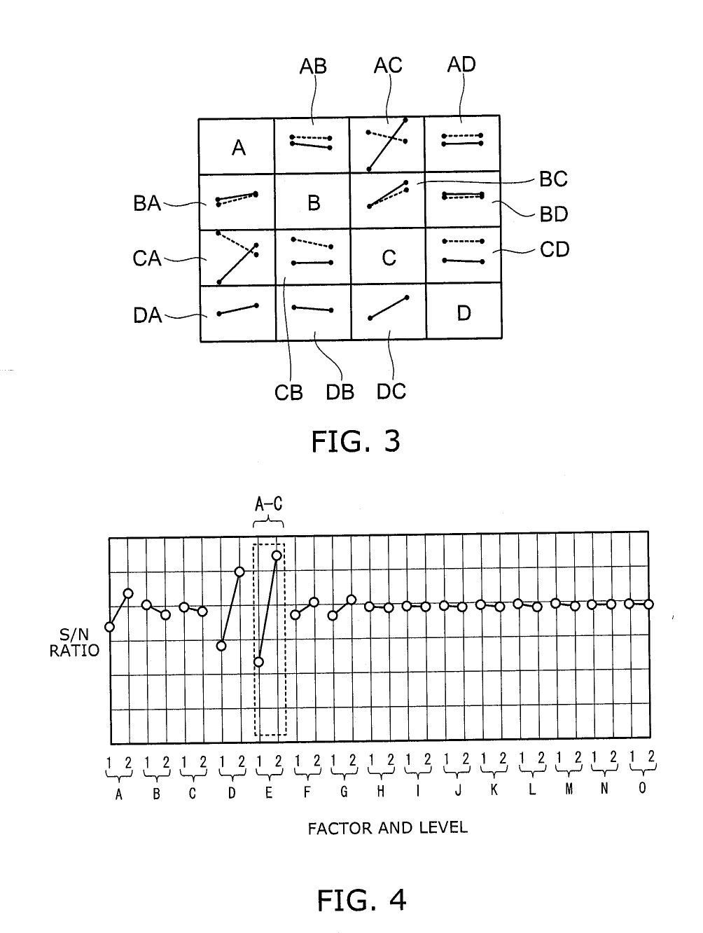

FIG. 3 is a diagram illustrating interactions by combinations of a plurality of parameters.

In FIG. 3, as an example, for the combinations (AB, AC, AD, BA, BC, BD, CA, CB, CD, DA, DB, and DC) of a plurality of parameters (A, B, C, and D), effects when each parameter for combination is changed are shown by plotted points and lines. The greater the degree of non-parallelness of the two lines shown in each combination of parameters is, the stronger the interaction is.

In step S202 of FIG. 2, it is assessed whether there is an interaction factor or not. In the case where there is no interaction factor, an experimental design is created in which the plurality of parameters are assigned to control factors (step S203). That is, an experimental design is created in which the plurality of parameters are assigned to control factors of an orthogonal array (L18 etc.). After the experimental design is created, an optimization experiment based on the experimental design is performed (step S204).

Then, from the experimental results, values of the parameters satisfying the characteristics of the objective and minimizing manufacturing variations of the product are determined to find an optimum solution (steps S211 to S213). The optimum solution is found through, for example, sensitivities and S/N ratios obtained from the experimental results of the parameters based on an orthogonal array. As an example of finding an optimum solution, standardized S/N ratio analysis according to Taguchi methods of quality engineering (step S211) is given.

On the other hand, in the case where it has been concluded that there is an interaction factor in step S202, the interaction factor is extracted (step S205).

FIG. 4 is a diagram illustrating the extraction of an interaction.

FIG. 4 shows an example in which interaction is investigated from the plotted points of the effects regarding the combinations of the plurality of parameters shown in FIG. 3. The interaction is investigated using, for example, a standard orthogonal array (L16 etc.). FIG. 4 shows a factorial effect diagram according to a standard orthogonal array (L16). Here, the horizontal axis of FIG. 4 represents the control factor (parameter), and the vertical axis represents, for example, the S/N ratio. From the factorial effect diagram, control factors by which the difference between two levels of S/N ratios exceeds a predetermined value are found, and a combination of parameters having an interaction is found from the components corresponding to the columns of the control factors in the orthogonal array. In the example shown in FIG. 4, there is a strong interaction between parameters A and C. In the extraction of an interaction, two or more sets of interaction factors may be extracted.

Next, one of the extracted interaction factors is assigned to a signal factor of dynamic characteristics (step S206). The interaction factor not assigned to the signal factor but left out of the extracted interaction factors and the other parameters not extracted as an interaction factor are assigned to control factors (step S207).

For example, in the case where the first parameter and the second parameter are extracted as interaction factors, the first parameter is assigned to a signal factor, and the second parameter is assigned to a control factor.

In the case where n (n being an integer of 2 or more) parameters are extracted as interaction factors, (n−1) parameters out of the n parameters are assigned to signal factors, and the other one parameter is assigned to a control factor. That is, in the case where a plurality of parameters that are interaction factors exist for one parameter, the plurality of parameters that are interaction factors are assigned to signal factors.

An experimental design is created by the assignment of the signal factor and the assignment of the control factor. For example, in an orthogonal array (L18 etc.), the control factor is assigned on the inner array, and the signal factor is assigned on the outer array. When there is an noise factor, it may be added on the outer orthogonal array.

Then, an experiment is performed based on the created experimental design.

Next, it is assessed whether or not there are ideal conditions (“ideal conditions” include the “ideal state,” the same applies hereinafter) in the evaluation characteristics for the signal factor (step S208). That is, based on the results of the experiment previously performed, it is assessed whether or not there are ideal conditions in the evaluation characteristics for the parameter that is a signal factor (e.g. the first parameter).

For example, in the case where ideal conditions of the evaluation characteristics for the signal factor have been found from the results of an experiment performed in the past or the like or ideal conditions have been simply found, or in the case where ideal conditions of the evaluation characteristics for the signal factor are found through sensitivities or S/N ratios obtained from the experimental results based on an orthogonal array, the ideal conditions of the evaluation characteristics for the signal factor or the ideal conditions simply found are taken as standard conditions. In the case where ideal conditions of the evaluation characteristics for the signal factor are taken as standard conditions, a standard characteristic curve is set for the characteristic curve expressing the relationship between the signal factor and the characteristics.

On the other hand, in the case where in the assessment of step S208 it has been concluded that there are no ideal conditions, specific conditions are taken as standard conditions (step S210). For example, in the case where it is impossible to obtain or make clear ideal conditions of the evaluation characteristics for the signal factor from the results of an experiment performed in the past or the like or it is impossible to simply obtain or make clear ideal conditions, or in the case where ideal conditions cannot be obtained through sensitivities or S/N ratios obtained from the experimental results based on an orthogonal array, the current best conditions of the control factor are taken as standard conditions. Also the best conditions obtained from the experimental results in investigating interaction may be taken as standard conditions. In the case where specific conditions are set for the control factor, a provisional characteristic curve is set for the characteristic curve expressing the relationship between the signal factor and the characteristics under the specific conditions.

Next, optimum values of the parameters are analyzed using the characteristic curve (step S211). Standardized S/N ratio analysis in Taguchi methods, for example, is used for the analysis of optimum values. Thereby, optimum values of the parameters are found.

Here, in the case where in step S209 a standard characteristic curve is set as a characteristic curve, values of the control factor and the signal factor (a parameter having an interaction) satisfying the characteristics of the objective are determined in a standardized S/N ratio analysis. Then, it is assessed whether the objective has been achieved or not (step S212), and when achieved, an optimum solution is determined (step S213).

On the other hand, in the case where in step S210 a provisional characteristic curve is set as a characteristic curve, it is assessed whether or not there are values of the control factor and the signal factor (a parameter having an interaction) satisfying the characteristics of the objective in accordance with the provisional characteristic curve in a standardized S/N ratio analysis (step S212). In the case where it has here been concluded that there are no values of the parameters satisfying the characteristics of the objective, the best characteristics are set as new conditions (step S214), and these are taken as standard conditions (step S210). Then, the provisional characteristic curve is altered by the standard conditions in which the new conditions have been set, and a standardized S/N ratio analysis is performed (step S211). The alteration of the provisional characteristic curve is repeated until values of the parameters satisfying the characteristics of the objective and minimizing manufacturing variations of the product are extracted. Then, the values of the parameters extracted are determined as an optimum solution (step S213).

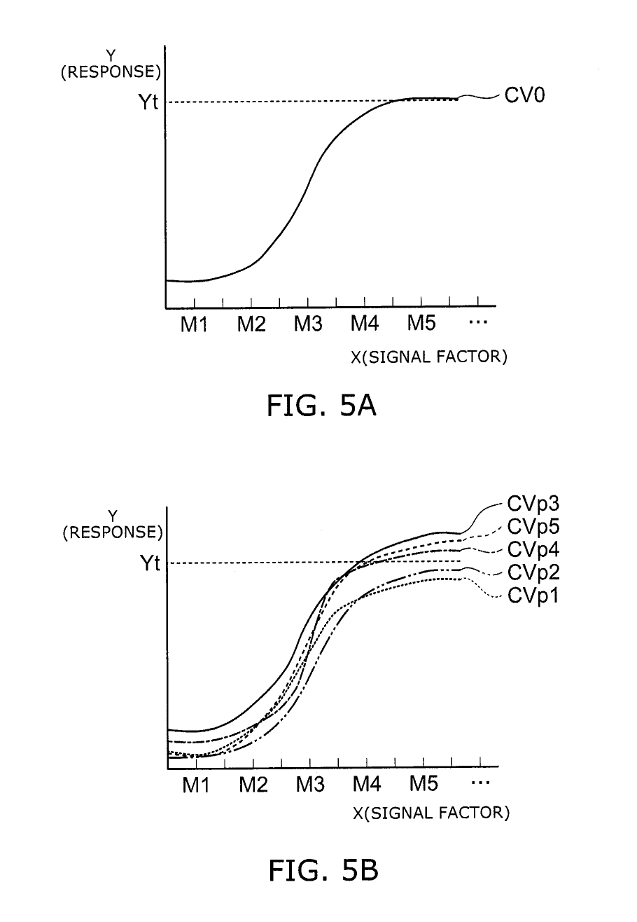

FIGS. 5A to 5B are diagrams illustrating relationships between the signal factor and the characteristics.

As shown in FIG. 5A, in the case where a standard characteristic curve CV0 is set as a characteristic curve, a value (level) of a signal factor X satisfying the target value Yt of characteristics is determined along the standard characteristic curve CV0.

In the case where the standard characteristic curve CV0 is not set as a characteristic curve, as shown in FIG. 5B, provisional characteristic curves (e.g. CVp1 to CVp5) are sequentially set as characteristic curves. That is, first, a provisional characteristic curve CVp1 is set, and it is assessed whether or not there is a value of the signal factor X satisfying the target value Yt of characteristics and variation conditions. In the case where there is no value of the signal factor X satisfying the target value Yt and variation conditions, the best conditions are extracted from the results and are set for the next provisional characteristic curve CVp2, and similarly it is assessed whether or not there is a value of the signal factor X satisfying the target value Yt of characteristics and variation conditions. Such an alteration of the provisional characteristic curve is repeated until a value of the signal factor X satisfying the target value Yt and variation conditions is extracted.

Here, in the case where a plurality of parameters having an interaction are assigned to signal factors X, a plurality of characteristic curves or a plurality of characteristic curved surfaces expressing the relationships with the signal factors X (including multi-dimensional relationships) are set for the same value of the control factor.

In the example shown in FIG. 5B, the provisional characteristic curves CVp3, CVp4, and CVp5 have a value of the signal factor X satisfying the target value Yt. Values of the signal factor X and the other parameters satisfying the target value Yt are extracted based on a characteristic curve minimizing manufacturing variations of the product (e.g. CVp5) out of the provisional characteristic curves CVp3, CVp4, and CVp5.

By such a method, even when there is a parameter that is an interaction factor, an optimum solution of parameters with consideration of this parameter is determined.

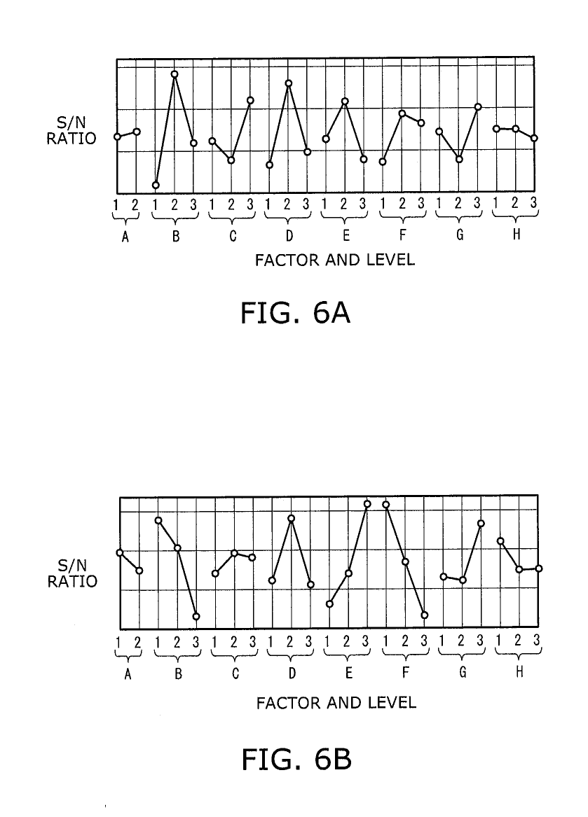

FIGS. 6A to 6B are diagrams illustrating a comparison between a reference example and the embodiment.

FIG. 6A shows the results of an experiment using an L18 orthogonal array in the case where interaction is not taken into consideration (graph of factorial effects). FIG. 6B shows the results of an experiment using an L18 orthogonal array to which the embodiment is applied (graph of factorial effects).

In the case where there is interaction between factors like the experimental results according to the reference example shown in FIG. 6A, the characteristics of peaks and troughs appear significantly in the graph of factorial effects. In the case where the influence of interaction is great, the influence of interaction cannot be completely avoided, and it is difficult to obtain an optimum solution of parameters.

Thus, since evaluation is performed while factors under the influence of interaction are excluded from the experiment, it is impossible to optimize factors having an interaction.

On the other hand, in the case where a parameter of an interaction factor is set using the embodiment shown in FIG. 6B, it can be seen that the characteristics of peaks and troughs are improved as compared to the graph of factorial effects of FIG. 6A. Thus, by using the embodiment, an optimum solution of parameters can be obtained while avoiding the influence of interaction.

### Second Embodiment

A parameter determination support program according to a second embodiment is what makes a computer execute the parameter determination support method according to the first embodiment described above.

When a product is manufactured, the parameter determination support program according to the embodiment determines a plurality of parameters satisfying the characteristics of the objective and minimizing manufacturing variations of the product.

That is, the parameter determination support program according to the embodiment makes a computer function as an extraction means, a creation means, a setting means, and a determination means.

The extraction means executes the extraction process (step S101 of FIG. 1) of the parameter determination support method described above.

The creation means executes the creation process (step S102 of FIG. 1) of the parameter determination support method described above.

The setting means executes the setting process (step S103 of FIG. 1) of the parameter determination support method described above.

The determination means executes the determination process (step S104 of FIG. 1) of the parameter determination support method described above.

The parameter determination support program may be recorded in a memory medium of a computer, a portable memory (a nonvolatile memory etc.), a disc-shaped recording medium, etc. and may be distributed via a network.

In such a parameter determination support program, an optimum solution of parameters can be obtained while avoiding the influence of interaction.

### Third Embodiment

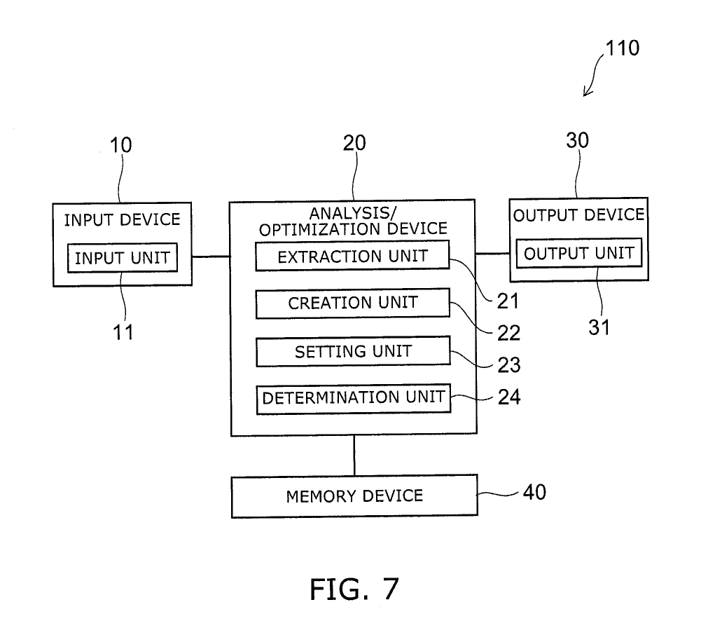

FIG. 7 is a block diagram showing a configuration of a parameter determination support system according to a third embodiment.

A parameter determination support system 110 according to the third embodiment includes an input device 10, an analysis/optimization device 20, and an output device 30. The parameter determination support system 110 may include a recording device 40.

The input device 10 includes an input unit 11 to which a plurality of parameters used in the manufacturing of a product satisfying the characteristics of the objective are inputted. The input unit 11 is, for example, a keyboard.

The analysis/optimization device 20 includes an extraction unit 21, a creation unit 22, a setting unit 23, and a determination unit 24.

The extraction unit 21 extracts parameters (at least the first parameter and the second parameter) that are interaction factors from the plurality of parameters inputted through the input unit 11.

The creation unit 22 creates an experimental design in which the first parameter extracted in the extraction unit 21 is assigned to a signal factor in dynamic characteristics and the second parameter and the other parameters extracted in the extraction unit 21 are assigned to control factors.

The setting unit 23 sets a characteristic curve expressing the relationship between the signal factor and the characteristics in regard to the experimental results based on the experimental design created in the creation unit 22.

The determination unit 24 determines a value of the first parameter, a value of the second parameter, and values of the other parameters satisfying the characteristics of the objective and minimizing manufacturing variations of the product out of the values of the first parameter, the second parameter, and the other parameters in accordance with the characteristic curve as optimum values.

The parameter determination support system may be embodied as a computer. In the parameter determination support system, for the input device 10, the analysis/optimization device 20, and the output device 30, a connection via a network such as an internet may be made between the input device 10 and the output device 30, and the analysis/optimization device 20.

In such a parameter determination support system, an optimum solution of parameters can be obtained while avoiding the influence of interaction.

As described above, the parameter determination support method, the parameter determination support program, and the parameter determination support system according to the embodiments can optimize parameters with sufficient consideration of interaction.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A parameter determination support method comprising:
extracting at least a first parameter and a second parameter that are interaction factors from a plurality of parameters used in manufacturing of a product satisfying a characteristic of an objective;
creating an experimental design, the first parameter being assigned to a signal factor in a dynamic characteristic and the second parameter and another parameter being assigned to control factors in the experimental design;
setting a characteristic curve expressing a relationship between the signal factor and the characteristic in regard to an experimental result based on the experimental design; and
determining a value of the first parameter, a value of the second parameter, and a value of the other parameter satisfying the characteristic of the objective and minimizing a manufacturing variation of the product out of values of the first parameter, the second parameter, and the other parameter as optimum values in accordance with the characteristic curve.

2. The method according to claim 1, wherein in the determining the optimum values,
a specific condition is set for the control factor, a provisional characteristic curve expressing a relationship between the signal factor and the characteristic under the specific condition is set for the characteristic curve, and the characteristic curve is altered until the optimum value is obtained.

3. The method according to claim 1, wherein in the determining the optimum values,
a standard characteristic curve expressing a relationship between the signal factor and the characteristic under an ideal condition of an evaluation characteristic for the signal factor is set as the characteristic curve in a case where the ideal condition is known.

4. The method according to claim 1, wherein in the determining the optimum values,
it is assessed whether an ideal condition of an evaluation characteristic for the signal factor is known or not,
a standard characteristic curve expressing a relationship between the signal factor and the characteristic under the ideal condition is set as the characteristic curve in a case where the ideal condition is known, and
a specific condition is set for the control factor, a provisional characteristic curve expressing a relationship between the signal factor and the characteristic under the specific condition is set for the characteristic curve as initial values, and the characteristic curve is altered until the optimum value is obtained in a case where the ideal condition is not known.

5. The method according to claim 1, wherein in a case where n (n being an integer of 2 or more) parameters that are interaction factors are extracted from the plurality of parameters,
(n−1) parameters out of the n parameters are assigned to the signal factors and the other one parameter is assigned to the control factor in the creating the experimental design.

6. The method according to claim 1, wherein a parameter that is a noise factor is assigned in the experimental design in a case where the noise factor is included among the plurality of parameters.

7. The method according to claim 1, wherein in the determining the optimum values,
a value of the first parameter, a value of the second parameter, and a value of the other parameter that are the optimum values are found by a standardized S/N ratio analysis.

8. A parameter determination support program configured to determine a plurality of parameters satisfying a characteristic of an objective and minimizing a manufacturing variation of a product in manufacturing the product and configured to make a computer function as
an extraction means configured to extract at least a first parameter and a second parameter that are interaction factors from the plurality of parameters,
a creation means configured to create an experimental design, the first parameter being assigned to a signal factor in a dynamic characteristic and the second parameter and another parameter being assigned to control factors in the experimental design,
a setting means configured to set a characteristic curve expressing a relationship between the signal factor and the characteristic in regard to an experimental result based on the experimental design, and
a determination means configured to determine a value of the first parameter, a value of the second parameter, and a value of the other parameter satisfying the characteristic of the objective and minimizing a manufacturing variation of the product out of values of the first parameter, the second parameter, and the other parameter as optimum values in accordance with the characteristic curve.

9. The program according to claim 8, wherein in the determination means,
a specific condition is set for the control factor, a provisional characteristic curve expressing a relationship between the signal factor and the characteristic under the specific condition is set for the characteristic curve, and the characteristic curve is altered until the optimum value is obtained.

10. The program according to claim 8, wherein in the determination means,
a standard characteristic curve expressing a relationship between the signal factor and the characteristic under an ideal condition of the control factor is set as the characteristic curve in a case where the ideal condition is known.

11. The program according to claim 8, wherein in the determination means,
it is assessed whether an ideal condition of the control factor is known or not,
a standard characteristic curve expressing a relationship between the signal factor and the characteristic under the ideal condition is set as the characteristic curve in a case where the ideal condition is known, and
a specific condition is set for the control factor, a provisional characteristic curve expressing a relationship between the signal factor and the characteristic under the specific condition is set for the characteristic curve as initial values, and the characteristic curve is altered until the optimum value is obtained in a case where the ideal condition is not known.

12. The program according to claim 8, wherein in a case where n (n being an integer of 2 or more) parameters that are interaction factors are extracted from the plurality of parameters in the extraction means,
(n−1) parameters out of the n parameters are assigned to the signal factors and the other one parameter is assigned to the control factor in creating the experimental design.

13. The program according to claim 8, wherein a parameter that is a noise factor is assigned in the experimental design in the creation means in a case where the noise factor is included among the plurality of parameters.

14. A parameter determination support system comprising:
an input unit, a plurality of parameters used in manufacturing of a product satisfying a characteristic of an objective being inputted to the input unit;
an extraction unit configured to extract at least a first parameter and a second parameter that are interaction factors from the plurality of parameters inputted through the input unit;
a creation unit configured to create an experimental design, the first parameter extracted in the extraction unit being assigned to a signal factor in a dynamic characteristic and the second parameter and another parameter extracted in the extraction unit being assigned to control factors in the experimental design;
a setting unit configured to set a characteristic curve expressing a relationship between the signal factor and the characteristic in regard to an experimental result based on the experimental design created in the creation unit;
a determination unit configured to determine a value of the first parameter, a value of the second parameter, and a value of the other parameter satisfying the characteristic of the objective and minimizing a manufacturing variation of the product out of values of the first parameter, the second parameter, and the other parameter as optimum values in accordance with the characteristic curve set in the setting unit; and
an output unit configured to output the optimum values determined in the determination unit.

15. The system according to claim 14, wherein in the determination unit,
a specific condition is set for the control factor, a provisional characteristic curve expressing a relationship between the signal factor and the characteristic under the specific condition is set for the characteristic curve, and the characteristic curve is altered until the optimum value is obtained.

16. The system according to claim 14, wherein in the determination unit,
a standard characteristic curve expressing a relationship between the signal factor and the characteristic under an ideal condition of the control factor is set as the characteristic curve in a case where the ideal condition is known.

17. The system according to claim 14, wherein in the determination unit,
it is assessed whether an ideal condition of the control factor is known or not,
a standard characteristic curve expressing a relationship between the signal factor and the characteristic under the ideal condition is set as the characteristic curve in a case where the ideal condition is known, and
a specific condition is set for the control factor, a provisional characteristic curve expressing a relationship between the signal factor and the characteristic under the specific condition is set for the characteristic curve as initial values, and the characteristic curve is altered until the optimum value is obtained in a case where the ideal condition is not known.

18. The system according to claim 14, wherein in a case where n (n being an integer of 2 or more) parameters that are interaction factors are extracted from the plurality of parameters in the extraction unit,
(n−1) parameters out of the n parameters are assigned to the signal factors and the other one parameter is assigned to the control factor in the creation unit.

19. The system according to claim 14, wherein a parameter that is a noise factor is assigned in the experimental design in the creation unit in a case where the noise factor is included among the plurality of parameters.
